(19) United States
(12) Patent Application Publication
(10) Pub. No.: US 2017/0118259 A1
(43) Pub. Date: Apr. 27, 2017

(54) TAGGING CONTENT FOR AUTOMATIC INCLUSION IN A FUTURE PRESENTATION

(71) Applicant: Avaya Inc., Santa Clara, CA (US)

(72) Inventors: Jitendra Wadhwa, Pune (IN); Suvarna Raju Madhey, Pune (IN); Amol Navale, Pune (IN); Sudhir Nivrutti Shelke, Pune (IN); Sameer Gengane, Pune (IN)

(21) Appl. No.: 14/923,566

(22) Filed: Oct. 27, 2015

(51) Int. Cl. H04L 29/06; G06F 3/0484; G06F 17/30

(52) U.S. Cl. CPC H04L 65/403; G06F 17/30601; G06F 3/04842

(57) ABSTRACT

Often it is desirable to present content (e.g., documents, websites, etc.) in a conference or meeting. Presenters may encounter relevant content at various times prior to the conference. Tracking content to be used in a presentation (e.g., conference, meeting, journal, etc.) is more easily facilitated by allowing a user to tag content and thereby associate the content with a conference. For example, a user may drag-and-drop a webpage to a calendar event associated with a conference or vice versa. When the conference occurs, the documents are presented or made available to the conference participants without requiring additional human action.

### FIELD OF THE DISCLOSURE

The present disclosure is generally directed toward conferencing systems and, more particularly, to the automatic inclusion of documents in a conference.

### BACKGROUND

In prior systems, a user in a meeting must manually enable the sharing of documents and other forms of media with the other participants in the meeting. For example, a user desiring to share a document accessed online, such as a web page, or any stored (offline) documents must make a note of such document and then manually open the document during the appropriate time in the presentation.

Similarly, if a user attending a conference finds interesting materials (e.g., slides, documents, etc.), which could be shared or referred to in the future, such as during a meeting, then the user must download the contents of the materials on their own system. The user then follows the same manual steps of referring to such contents during their future presentation. This process is quite cumbersome as a user must follow various manual steps, track the materials, and, furthermore, refer to these documents during the future presentation.

### SUMMARY

It is with respect to the above issues and other problems that the embodiments presented herein were contemplated. The prior art of conferencing and content sharing systems fails to enable a user to refer to documents of a conference automatically during the scheduled time of a meeting or presentation. In one embodiment, and as a general introduction to the embodiments disclosed herein, a user tags content (e.g., local and/or remote documents, web pages, etc.) with calendar events, such as a conference or meeting. At the scheduled time, the content is accessed automatically without requiring manual intervention. Participants may then access the content by selecting an appropriate indicia of the content.

In one embodiment, content is automatically referenced during a meeting or conference scheduled at a specific time. Thus, a user can tag any accessible content (e.g., document, web page, etc.) by using a conference identifier or other unique identifier. The content is then linked to a specific presentation. The tagging may synchronize with the content such that a user or owner of the content is updated/notified when the conference starts or when the conference becomes active.

In another embodiment, content is selected for inclusion in a conference or meeting upon tagging by the user. Tagging then causes the content to be associated with a particular calendar invitation or event. Tagging may be provided by a user input within the content's viewing application, such as by right clicking on the content and selecting an available tag, or creating a new tag, indicating a meeting request or a conference identifier. The method may then automatically identify the timing of the conference based on the conference identifier and, in one embodiment, based on parsing the conference meeting request from the calendar invite. In another embodiment, a user is attending a conference and wants to tag content presented by another user. The user can directly tag that particular content, such as by taking the permission from the first user and, thereafter, the content is tagged with the conference identifier and can be viewed during the time of the conference in which it was tagged.

In one example, a committee member is reviewing content and searches in their stored content and/or through a web portal (i.e., online) and finds content relevant to the discussion of the content at an upcoming conference. The user may then tag the content with a meeting or conference identifier from a calendar invite or by otherwise providing a unique conference identifier. Consequently, a link to the content or a copy of the content is created along with a timer associated with these references such that when the associated conference begins, the copied/linked references tagged may be displayed dynamically to the user at the time of the conference and thereafter the user may wish to share this with conference participants during the conference.

In another example, a user attends a web conference and wishes to share one of their conference slides in a future conference of their own. The user may then tag the slide (online or local) causing a server to associate the slide with the future conference. In another embodiment, the user may also take permissions from the author/host for the content to allow the user to share the content in the future conference. A server then automatically presents the tagged content during a conference's scheduled time and thereby simplifies the process of sharing content during a conference.

In one embodiment, a server is disclosed, comprising: a network interface; a processor; a data storage accessible to the processor; the processor, upon the occurrence of a time event, accesses a record in the data storage, the record comprising tagged content and, the processor accesses the record comprising tagged content, and causes indicia of the tagged content to be presented by a user device.

In another embodiment, a method is disclosed, comprising: presenting content on a user device; receiving an input, by a user interacting with the user device, indicating an association between the content and a conference occurring in the future; in response to receiving the indication of the association, causing a conferencing server to associate the conference with the content; and upon the occurrence of the conference, presenting the content association to a user device of a viewer of the conference.

In another embodiment, a method is disclosed, comprising: presenting indicia of a conference on a user device, the conference occurring in the future; receiving an input, by a user interacting with the user device, indicating an association between the conference and a content; in response to receiving the indication of the association, causing a conferencing server to associate the conference with the content; and upon the occurrence of the conference, presenting the content association to a user device of a viewer of the conference.

The terms “meeting,” “conference,” and “event,” as used herein, each refer to a presentation upon a user's networked computing device and involving one or more users as participants to receive the presentation.

The term “presentation,” as used herein, refers to the presenting of content for viewing by a user or users, such as on a display associated with a computing device. The presentation may by encompassed by and/or integrated with other content, such as a meeting, conference, lecture, journal, or other application. It should be appreciated that audio and/or tactile outputs (e.g., Braille displays) are also contemplated herein as providing viewing means to a user.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation, or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first desktop in accordance with embodiments of the present disclosure;

FIG. 2 depicts a second desktop in accordance with embodiments of the present disclosure;

FIG. 3 depicts a third desktop in accordance with embodiments of the present disclosure;

FIG. 4 depicts a conference application window in accordance with embodiments of the present disclosure;

FIG. 5 depicts a system in accordance with embodiments of the present disclosure; and

FIG. 6 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

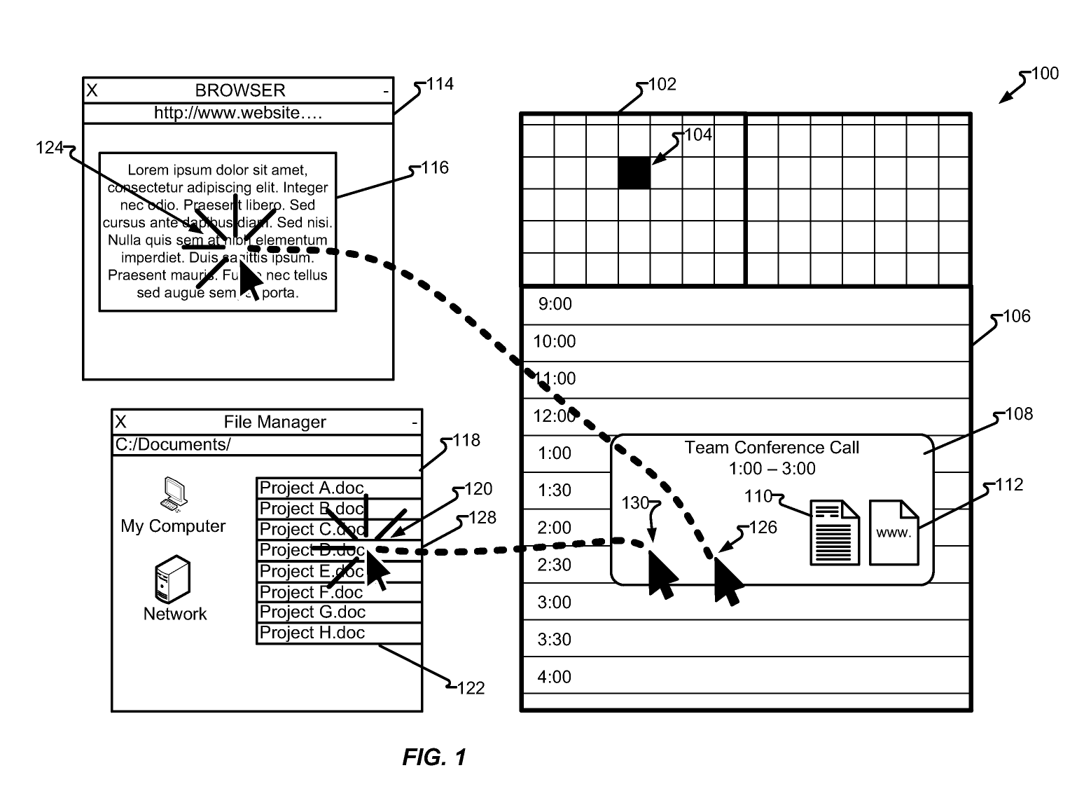

FIG. 1 depicts desktop 100 in accordance with embodiments of the present disclosure. FIG. 1 illustrates one embodiment wherein a user may select and tag content to be included in a future event. In one embodiment, desktop 100 comprises a number of application windows, which may be concurrently displayed. For example, calendar 102, browser 114, and/or file manager 118 may be presented on desktop 100. Calendar 102 may present a number of calendaring options such as a selection of a current day 104, and daily commitments 106 (e.g., tasks, appointments, calls, meetings, events, etc.). In another embodiment, calendar 102 comprises event 108.

Event 108 may be established in accordance with the user associated with desktop 100 or by another party who invited the user associated with desktop 100 to join event 108. A user associated with desktop 100 may wish to incorporate content encountered on websites or other sources into the event. In one embodiment, the user associated with desktop 100 is browsing content (e.g., website, web pages, media, etc.) on a network (e.g., Internet) using browser 114 and encounters webpage 116, which the user determines is of interest to event 108. The user performs selection 124 and drags the pointer to position 126, whereby indicia of the webpage 116 112 is provided in event 108 and webpage 116 is tagged to event 108. In another embodiment, the user associated with desktop 100 wishes to include a file, such as on a local drive or server. Selection 128 is made upon an indicator of file selection 120 and file listing 122 for dragging to position 130. After which, indicia of the file 110 is presented in, or associated with, event 108.

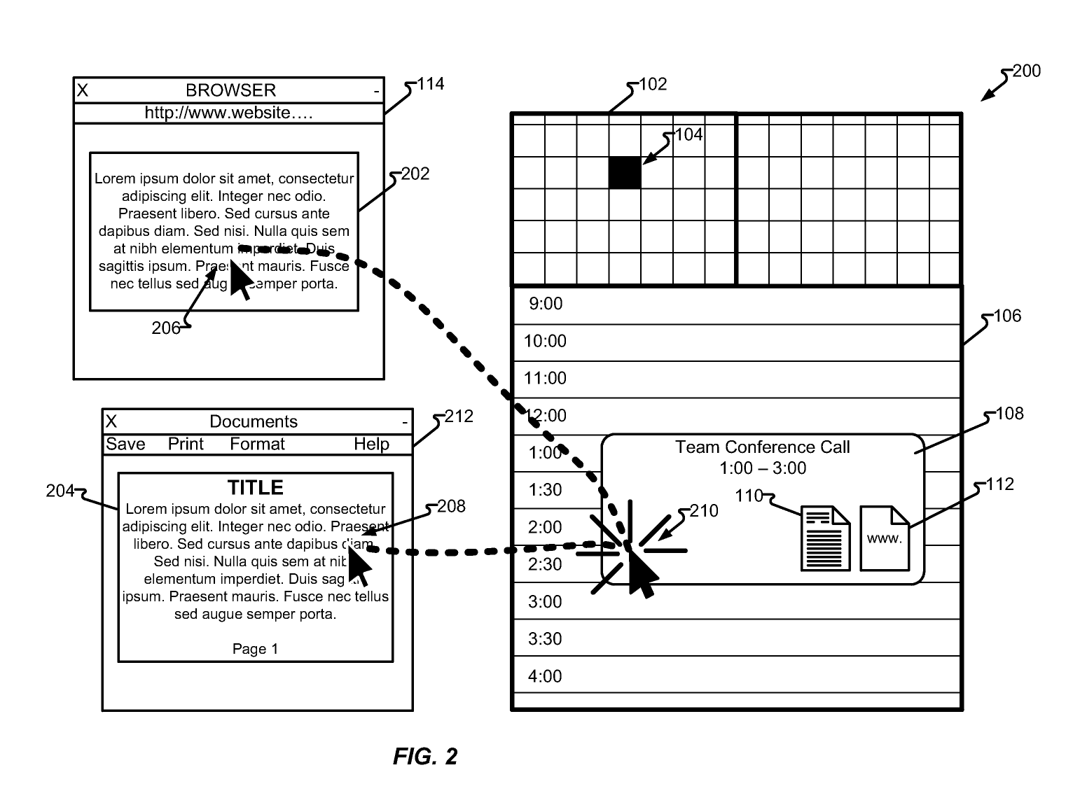

FIG. 2 depicts desktop 200 in accordance with embodiments of the present disclosure. FIG. 2 illustrates an embodiment wherein content for inclusion in a future event (e.g., event 108) is selected for inclusion by dragging indicia of event 108 to the content. In one embodiment, desktop 200 presents calendar 102, browser 114, and word processor 212. Upon selection 210 of event 108, indicia of event 108 may be dragged to browser 114 and dropped 206 on webpage 202. After which, indicia of the webpage 202 may be provided in event 108. In another embodiment, selection 210 is dropped 208 on word processor 212 having document 204 therein. After which, indicia of document 110 is provided in event 108.

The user action to tag content to event 108, or vice versa, may be performed by drag-and-drop operations illustrated with respect to FIG. 1 and FIG. 2. In another embodiment, a drop-down menu item or other selection option may be provided to one or more of calendar 102, browser 114, file manager 118, and word processor 212 in order to associate content with event 108.

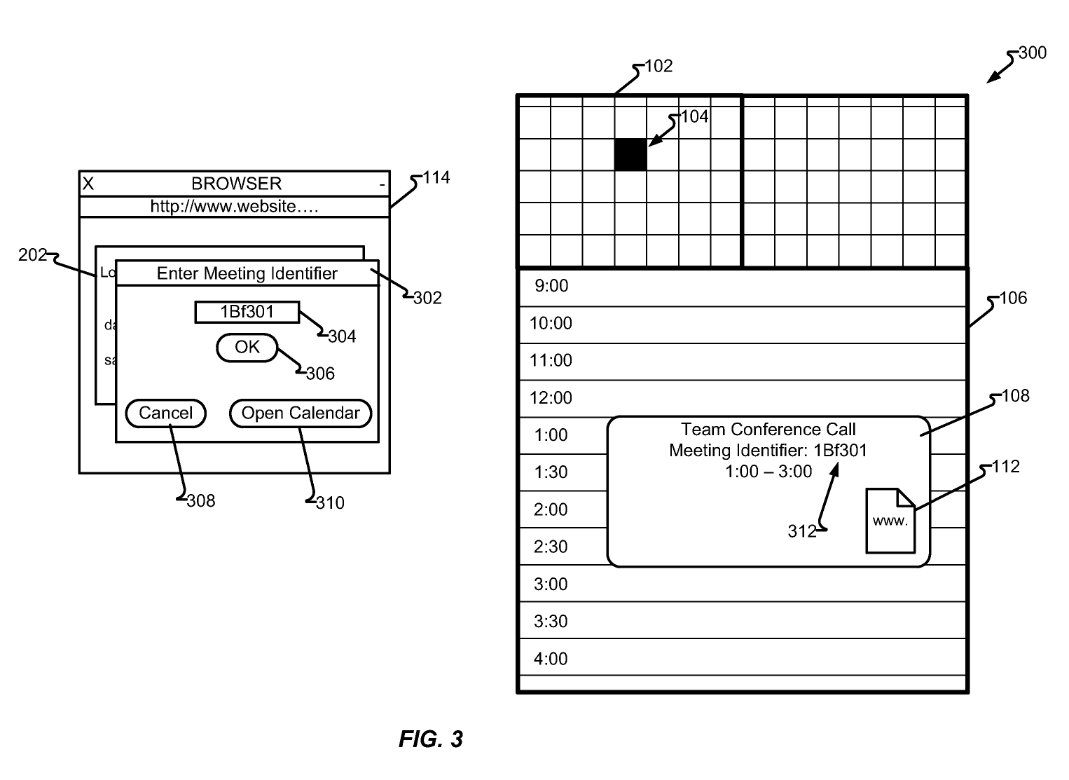

FIG. 3 depicts conference application window 300 in accordance with embodiments of the present disclosure. In one embodiment, content management applications, such as web browser 114, file manager 118, and/or word processor 212 may be provided with a selection option, such as a dialog box, wherein an identifier of event 108 may be provided.

In one embodiment, the user interacts with browser 114 displaying website 202. Browser 114 may be provided with a menu item or other indicator whereby the user may select to add an associated meeting and thereby bring up dialogue 302. Dialogue 302 provides field 304 for the entry of the meeting identifier associated with a particular event, such as event 108. Event 108 may have indicator 312 uniquely identifying the meeting or event. Dialogue 302 is provided with identifier 312 via manual entry selection of events known to a particular user or otherwise associated with calendar 102, or other means of data entry. Cancel button 308 allows the user to terminate the association process and open calendar button 310 may allow calendar 102 to be opened, if not otherwise available, upon entry by clicking OK button 306. After clicking OK button 306, the association between webpage 202 and event 108 may then be established.

In another embodiment, calendar 102 may provide a menu or other option to provide a location of content. For example, a user may provide calendar 102 with a file location, URL, or other identifying location of content.

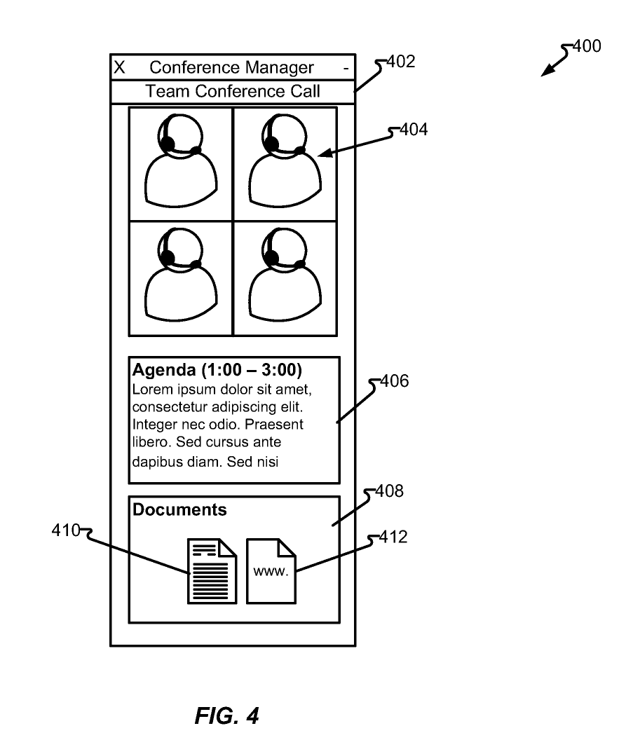

FIG. 4 depicts conference application window 400 in accordance with embodiments of the present disclosure. In one embodiment, application window 400 presents teleconferencing dialogue 402 to a user. Application window 400 may present a variety of teleconferencing indicators, such as participants 404, a current speaker, agenda 406, and/or other teleconferencing information. In another embodiment, content 408 is provided by application window 402.

In another embodiment, content 408 comprises document indicia 410 and website indicia 412. The occurrence of the particular event, such as event 108 (see FIGS. 1-3), and the association of content prior to the event cause dialogue 402 to present indicia of 410 and/or 412 accordingly.

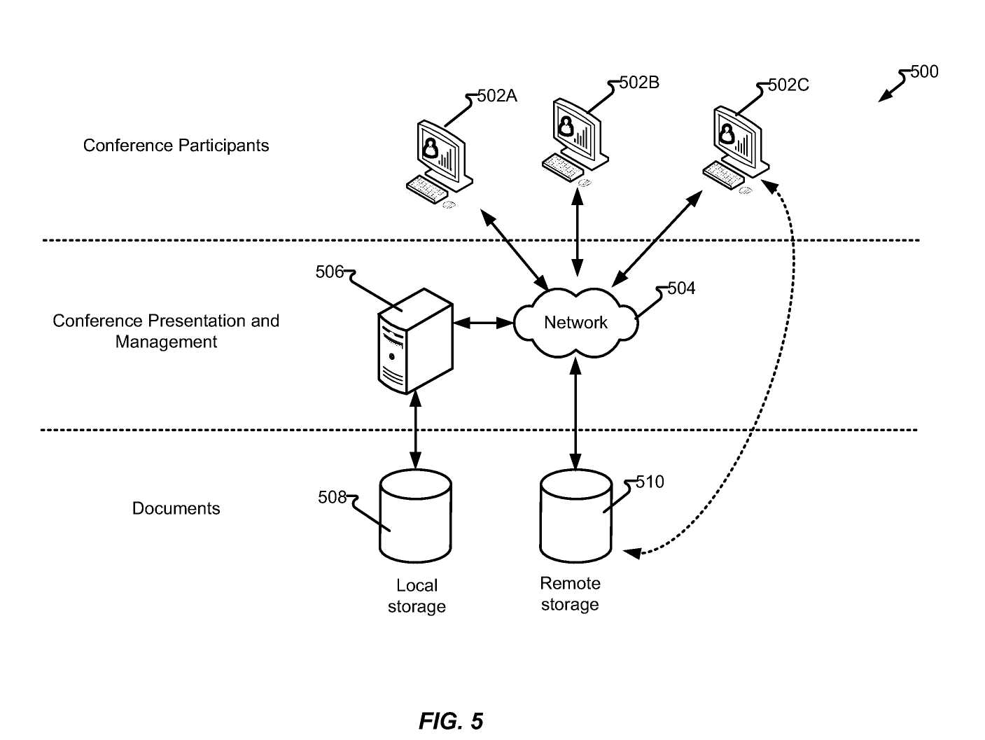

FIG. 5 depicts system 500 in accordance with embodiments of the present disclosure. The mechanism to associate content with a particular event, and vice versa, as well as retrieve the content upon the occurrence of the event is variously embodied. In one embodiment server 506 attaches to network 504 and local storage 508 maintains associations with documents and other local files utilized in a conference. Server 506 may provide conferencing services, such as floor control, participant management, time management, media streaming, etc., as well as cause devices 502 associated with conference participants to present certain conference content.

In one embodiment, device 502C comprises remote storage 510 having a file stored thereon to be presented during a conference. Server 506, accessing remote storage 510 via network 504, may access the content and provide a link to conference participant devices 502. In another embodiment, server 506, upon receiving the association between the conference and the file located in remote storage 510, retrieves a local file, such as for storage in local storage 508, and provides a link to the file as located in local storage 508 to conference participants 502 upon the occurrence of the conference event.

In another embodiment, network 504 comprises a combination of local and/or Internet networks. Remote storage 510 may be associated with a website, remote file storage, remote device, and/or other nonlocal asset. User 502C may establish an association between a conference in the file located in remote storage 510, which is then maintained by server 506, such as by storing a record in local storage 508 to provide a link to the file in remote storage 510 to devices 502C upon the occurrence of the event.

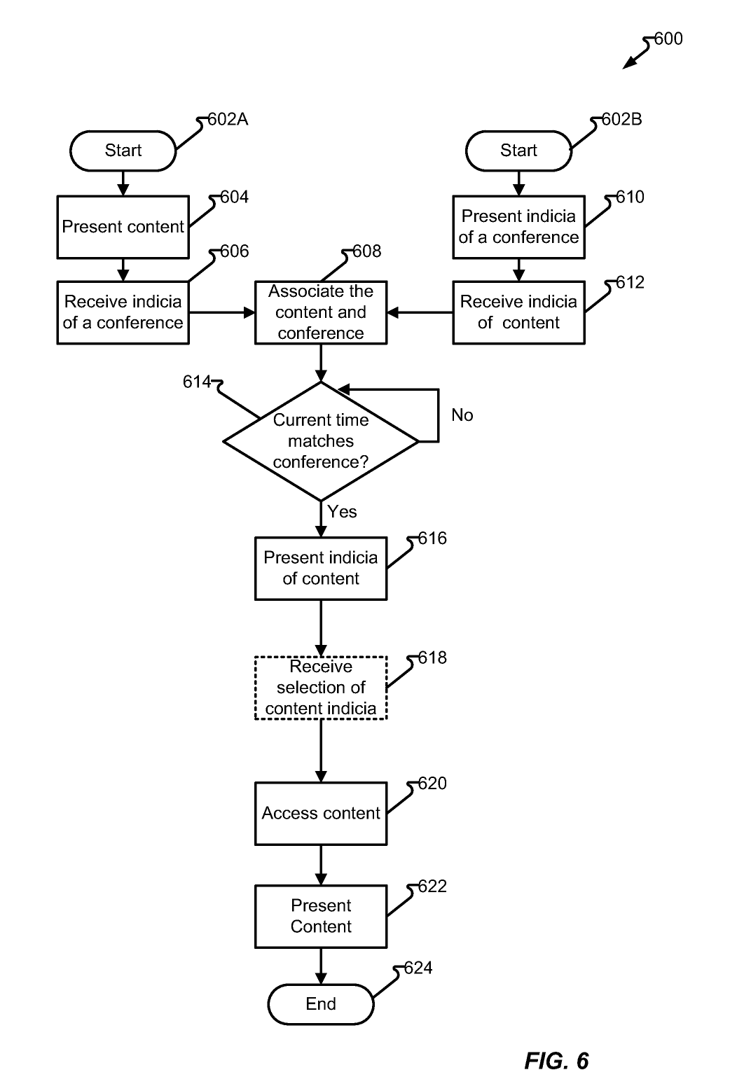

FIG. 6 depicts process 600 in accordance with embodiments of the present disclosure. In one embodiment, process 600 begins at start 602A. Next, step 604 presents content on a user device, such as a computer, laptop, smart phone, etc. Step 606 then receives indicia of a conference to be associated with the content presented in step 604. In another embodiment, process 600 begins at start 602B. Next, step 610 presents indicia of a conference. For example step 610 may present calendar 102 having event 108 thereon. Step 612 then receives indicia of content to be associated with the event. Step 606 and step 612 may be accomplished via the drop-down menu, drag-and-drop, manual entry, and/or other input that may be supported by a particular application and/or computing device.

Step 608 associates the content of the conference whereby a timer is started, such as at server 506, to present indicia of associated content to be presented to at least one user or participant of a conference. Next, step 614 determines if the conference time and the current time coincide. If no, step 614 may loop until such time as process 600 is canceled or step 614 is determined in the affirmative.

Step 616 presents indicia of the content, such as dialogue 402 presenting indicia 410 and/or 412 on a device, such as device 502. Optionally, step 618 may receive a selection of content indicia, such as a user selecting a particular icon. Following step 618 or following step 616, if step 618 is omitted, step 620 accesses the content associated with the indicia. Step 620 may retrieve a file, webpage, media file, and/or other content in its native environment and/or as may be copied locally, such as to local storage 508 accessible to server 506. Step 622 then presents the content to a user device in order to facilitate discussion or other purpose as the particular conference may require. After which, step 624 may end process 600.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this content, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

While illustrative embodiments of the disclosure have been described in detail herein, it is to be understood that the inventive concepts may be otherwise variously embodied and employed and that the appended claims are intended to be construed to include such variations, except as limited by the prior art.

What is claimed is:

1. A server, comprising:
a network interface;
a processor;
a data storage accessible to the processor;
the processor, upon the occurrence of a time event, accesses a record in the data storage, the record comprising tagged content and, the processor accesses the record comprising tagged content, and causes indicia of the tagged content to be presented by a user device.

2. The server of claim 1, wherein the indicia of the tagged content comprises a link to the content location within the data storage.

3. The server of claim 1, wherein the indicia of the tagged content comprises an Internet address.

4. The server of claim 1, wherein the processor causes the network interface to present the conference to the user device.

5. The server of claim 1, wherein the processor, receives a signal from the user device via the network interface and, in accordance with the signal, downloads the content to the user device.

6. The server of claim 1, wherein the processor, receives a signal from the user device via the network interface and, in accordance with the signal, downloads a link to the content to the user device.

7. The server of claim 1, wherein the time event is determined to take place at a time associated with a conference, the conference being associated with the record.

8. The server of claim 7, wherein the time event is determined to take place at a time associated with at least one of a speaker or an agenda item of the conference.

9. The server of claim 1, wherein the processor causes indicia of the tagged content to be presented by a user device, further comprises the processor causing indicia of the tagged content to be presented to a conferencing application executed by the user device.

10. A method, comprising:
presenting content on a user device;
receiving an input, by a user interacting with the user device, indicating an association between the content and a conference occurring in the future;
in response to receiving the indication of the association, causing a conferencing server to associate the conference with the content; and
upon the occurrence of the conference, presenting the content association to a user device of a viewer of the conference.

11. The method of claim 10, wherein the server associates the conference with the content by maintaining a link to the content.

12. The method of claim 10, wherein the server associates the conference with the content by maintaining a copy of the content.

13. The method of claim 10, wherein the association comprises a conference identifier of the conference.

14. The method of claim 10, wherein the association comprises updating a conference identifier of the conference from an existing conference identifier to a new conference identifier.

15. The method of claim 10, wherein the presenting of the content further comprises presenting indicia of the content within the conference.

16. A method, comprising:
presenting indicia of a conference on a user device, the conference occurring in the future;
receiving an input, by a user interacting with the user device, indicating an association between the conference and content;
in response to receiving the indication of the association, causing a conferencing server to associate the conference with the content; and
upon the occurrence of the conference, presenting the content association to a user device of a viewer of the conference.

17. The method of claim 16, wherein the server associates the conference with the content by maintaining a link to the content.

18. The method of claim 10, wherein the server associates the conference with the content by maintaining a copy of the content.

19. The method of claim 10, wherein the association comprises a conference identifier input to the user device.

20. The method of claim 19, wherein the association comprises a conference identifier input to the user device received by an input operation of an application utilized to present the content on the user device.
